(19) United States
(12) Patent Application Publication
(10) Pub. No.: US 2015/0003238 A1
(43) Pub. Date: Jan. 1, 2015

(54) SYSTEM AND METHOD FOR MANAGEMENT AND CONTROL OF COMMUNICATION CHANNELS

(71) Applicant: Alexander Y. Kalmikov, (US)

(72) Inventor: Alexander Y. Kalmikov, (US)

(21) Appl. No.: 13/931,947

(22) Filed: Jun. 30, 2013

(51) Int. Cl. H04W 72/04; H04W 28/02

(52) U.S. Cl. CPC H04W 72/0486; H04W 28/0289
USPC 370/230

(57) ABSTRACT

A system and method (here and after as the “inventive concept”) allows controlling and managing channels of communications between users. The invention includes a central processing unit which includes a software with a channel control algorithm that allocates available capacity of time between the users, i.e. the subscribers. The software further includes contributions or attributes of the subscribers to optimize utilization of bandwidth and/or network resources.

### FIELD OF INVENTION

This invention pertains generally to the field of mobile devices and management systems and, more particularly, to managing applications for mobile devices.

### BACKGROUND OF THE INVENTION

In a manner similar to personal computers and laptops, business enterprises increasingly rely on mobile and handheld devices. Indeed, the capabilities and uses of mobile devices have moved beyond voice communications and personal information management applications to a variety of communications- and business-related functions including email, browsing, instant messaging, enterprise applications, and video applications. For example, the functionality of many mobile devices have been extended to include cellular and wireless local area network (WLAN) communications interfaces, as well as virtual private network (VPN) and other client applications. Furthermore, mobile devices used in enterprises may also include enterprise applications used by employees in the field or otherwise.

Deployment, management and configuration of mobile and handheld devices in enterprise environments, however, present certain challenges. For example, the vast and constantly changing variety of mobile device types, functions and capabilities presents challenges to configuration, provisioning and troubleshooting. Moreover, the number and variety of applications that can be installed on mobile devices, as well as the nature of the mobile devices themselves, challenges network administrators relative to network security, deployment and overall management. The art is replete with various prior art systems and methods.

For example, U.S. Pat. No. 8,117,074 to Boss et al teaches the use of a Chip Conversion Factor (CCF) to scale offers for EBRs. The CCFs are a multiplier that will be applied to offers received for the EBRs. In general, the CCF can be computed based on any number of factors such as the cost of the EBRs, the worth of an EBR to a potential buyer (e.g., at a particular time), a customer status (e.g., preferred customer) of a potential buyer, etc. The invention helps to take into account any differences between EBRs that meet a potential buyer's requirements but that may affect the value of the EBRs relative to one another.

Another prior art reference, such as, for example, U.S. Pat. No. 8,131,616 to Semret et al, teaches a method for controlling access to a system of finite resources with excess demand employs a two stage admission process. Subscribers are first admitted based on an initial bid price and resource availability. The market price is determined by the highest bid price among the rejected arrivals in the current batch. Admitted subscribers are then given the option to secure continued access to the resource by accepting a fee-based reservation. The fee for the reservation is determined in a manner which is fair to the reserving subscriber, as well as all other subscribers, in that the reservation fee is priced to provide access at a cost which prevents arbitraging opportunities. If the current market price exceeds a non-reserved subscriber's bid price, that non-reserved subscriber is displaced. If the current market price exceeds a reserved subscriber's bid price, that reserved subscriber's reservation is activated and access to the resource continues. In the case of a communications system having a finite number of access lines, the reservation fee is based on the bid price from the subscriber and the duration of the requested reservation.

Alluding to the above, U.S. Pat. No. 8,170,048 to Gossett et al, teaches a computer program products, in which access allocations to a spectrum band and transmit rights to the access allocations are defined. Real-time auction bids for the transmit rights to the access allocations to the spectrum band are sent from a participating device, and the participating device iteratively increments the bids until a maximum bid is reached or a transmit right is awarded to the participating device.

Another prior art reference such as, for example, U.S. Pat. No. 8,194,701 to Khan et al teaches a system and method where digital objects may be transmitted to a destination via data networks. In particular, a node may facilitate bidding for the business of forwarding digital objects in a data transmission network. The node may receive a first bid request and generate a second bid request based on the first bid request. The second bid request may be transmitted to one or more intermediary nodes, and the node may receive one or more bids responsive to the second bid request. The node may subsequently receive and forward a digital object specified by the first bid request.

U.S. Pat. No. 8,260,959 to Rudkin et al teaches a method of selecting a suitable service for the delivery of a communication across an integrated network is disclosed. Before now, users had to select the service that best suited their needs at the time of each delivery. By providing a computer programmed to act as a purchasing agent with data indicating the desirability of stability in the network service an automatic selection of the service to be provided to the communication is enabled. An embodiment is described in which different degrees of stability are given to different content file deliveries in dependence on the importance attached to the recipient by a content provider. The invention could equally be used to provide an appropriate services for many different types of network traffic.

Still another prior art reference, namely, U.S. Pat. No. 8,244,562 to Jain et al teaches a system that provides an architecture for facilitating equilibrium solutions for resource allocation markets. One particular example of such markets can be a computer network environment. The architecture can model buyers as nodes and suppliers as edges, incorporating notions of an ascending price auction in order to provide optimal equilibrium solution to Eisenberg-Gale type convex programs in strongly polynomial time.

United States Publication No. 20130035060 to Chan et al teaches a method is provided for acquiring bandwidth on a mobile device. A bid for bandwidth service on the mobile device is submitted to service providers, which includes: a bandwidth requisition, a plurality of service criteria (each with a weighting factor), and at least one limiting condition. Responses from the service providers are evaluated using the weighting factors to compute a score. The best scoring response that meets the at least one limiting condition is automatically chosen, and a transaction is entered into with the chosen service provider to acquire the bandwidth service on the mobile device according to the service criteria. The bid may also be submitted to (and the transaction negotiated with) a central bidding server which intermediates bids received from many users.

United States Publication No. 20120201127 to Voit et al., on the other hand, teaches a computer network includes first and second Ethernet access domain networks, each of Ethernet access domain networks including a user-facing provider edge (u-PE) device, and a stack group of network-facing provider edge (n-PE) devices coupled with the u-PE device, the n-PE devices running a bidding protocol to select one of the n-PE devices as a primary n-PE device for a single pseudowire connection path between the first and second Ethernet access domain networks. It is emphasized that this abstract is provided to comply with the rules requiring an abstract that will allow a searcher or other reader to quickly ascertain the subject matter of the technical disclosure.

There are several other earlier prior art references such as U.S. Pat. No. 5,303,297 to Hillis, U.S. Pat. No. 5,606,602 to Johnson et al, U.S. Pat. No. 5,905,975 to Ausubel, U.S. Pat. No. 6,009,154 to Riken et al, and U.S. Pat. No. 7,177,832 to Semret et al. The U.S. Pat. No. 5,303,297 to Hillis teaches communication system service billing arrangement is described that adapts to system loading in real time. As system loading varies, one or more individual subscribers units (ISU) of a communication system are provided with realtime information on the current cost of the communication service. The system determines the locations of the ISUs and the current loading there between and calculates a calling rate based at least on the current loading. This calling rate is sent to at least one of the ISUs whose operator can choose to connect or not connect the call between the ISUs based on the current realtime variable rate.

The U.S. Pat. No. 5,606,602 to Johnson et al, for example, teaches telecommunication switches (e.g., PBX's or local exchange carrier's switches) route calls in accordance with economic incentives (e.g., least cost routing) resulting from a bidding process between participating interexchange telecommunication carriers (Carriers) by operation of a central processor, a computer referred to as a bidding moderator (Moderator). Each of the Carriers informs the Moderator of the rate it is willing to charge (or other economic incentive it is willing to offer) for service between two specific points in the telecommunication network at some particular time. The Moderator collects this bid information from all the Carriers, sorts it among originating points and transmits it to an adjunct processor at each subscribing switch location and to all participating Carriers' network management centers. From the list of all Carriers providing bid information to the Moderator, each Subscriber can select those Carriers to which it wants traffic routed and can change that selection at any time. After each new bid is submitted by a Carrier and is processed by the Moderator, it is distributed to both the relevant Subscribers and all other Carriers. All Carriers have the opportunity to submit at any time a lower or higher bid for any point-to-point routes on which they wish, respectively, to stimulate or discourage additional traffic. The Moderator could offer a different class of service to end users who are calling parties by broadcasting each carrier's bid to an interface unit at each user location.

Finally, the U.S. Pat. No. 7,177,832 to Semret et al teaches a system and method for allocating a resource using a progressive second price auction technique. An auction is held for a limited resource, such as bandwidth in an Internet Service Provider Network in which bids are submitted by prospective users including the quantity desired and the price for each unit of resource bid upon. In order to make an efficient allocation, a new bidder is granted some of the resource based upon the availability of the limited resource due to the bids higher than the new bidder. The actual price paid by the new bidder is based upon bids made with lower prices who have been or would have been allocated some of the resource. This calculation of the price paid encourages bidders to bid their actual valuation of the resources rather than engage in inefficient tactical bids.

Therefore, there is an opportunity and a constant need for improved systems and methods for mobile devices and management systems and, more particularly, to managing applications for mobile devices with increased reliability, efficiency and technological simplicity in design that will eliminate all deficiencies and drawbacks of the prior art applications, systems, methods, and designs.

### SUMMARY OF THE INVENTION

An operation support system (the system) for management of communication channels invention wherein communication is established between service providers and subscribers. The system includes a central request synchronization server (the RQSS), a subscriber software, and a requestor synchronization protocol software (the RSP) for providing interaction between the subscriber software and the RQCC thereby decreases subscriber's activity during channel congestion and allowing for idling of the channel when the subscribers' activity to allow control of the communication channels thereby minimizing the duration of the channels idling and overloading periods and ensure maintenance of the channels loading.

The invention includes numerous advantages of the prior art applications. The invention was designed to eliminate of the problems associated with and not solved by prior art systems. Such problem is prevention of the achieving of the maximum commercial efficiency of a Channel within the operating networks. To solve this problems, the inventive software provides the following advantages of the prior art systems. In particular, the invention decreases of the Subscriber's activity (with possible ceasing the network activity) during Channel congestion. The invention further provides and allows for “idling” of the Channel when the Subscribers' activity is low.

One of the main advantages of the present invention is to provide an improved and unique system approach to arrange of control of a communication channel, which would minimize the duration of the channel's idling and overloading periods and ensure maintenance of the channel loading on the level close to 100%.

Another advantage of the present invention is ensured by the use of a conceptually new approach (paradigm) to the channel control process, under which the subscribers of the Operator are included into the control circuit, while the level of demand for the service and the factors of the subscribers' satisfaction are converted into the input parameters employed in the channel control algorithm.

Still another advantage of the present invention is to provide a system of management control of communication channels wherein the system allows to receive information about communication channel accessibility. The information may include current information (to understand the current situation), future information (for planning of activities), and past information (for better quality /validity of planning).

Still another advantage of the present invention is to provide the improved system of management of communication channels to allow to plan network activity based on the current and forecast communication channel accessibility.

Still another advantage of the present invention is to provide improved system and management of communication channels adaptable to generate signals of their satisfaction in a real time and cooperate with the Operator and other subscribers in order to increase the quality of the services.

The subject of the invention was developed within the project, will be an integrated software solution, intended for the integration into the OSS of communication service providers in order to enhance commercial efficiency of existing communication channels. The Solution will be developed so as to enable its integration into existing OSS with minimum costs risks for networks and current business logics of the Operator.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIGS. 1 and 2 illustrate various schematic views of the operable components of the present invention operably communicated with one another and

FIG. 3 shows a graph that shows benefits of present invention over prior art systems.

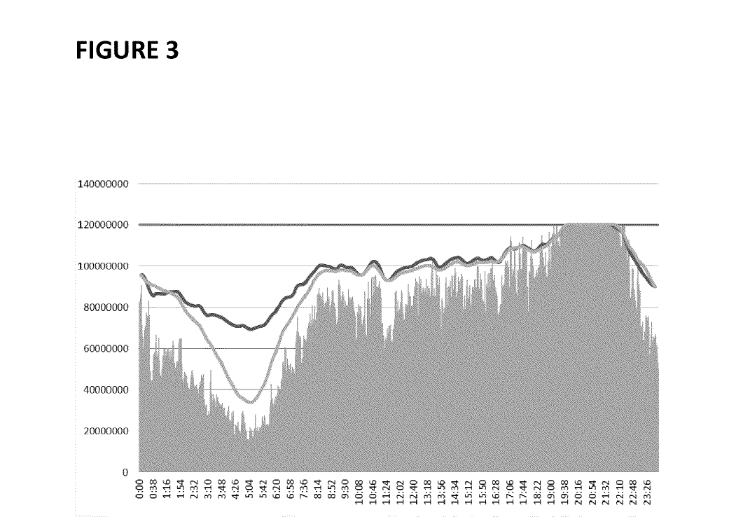

### DETAILED DESCRIPTION OF THE INVENTION

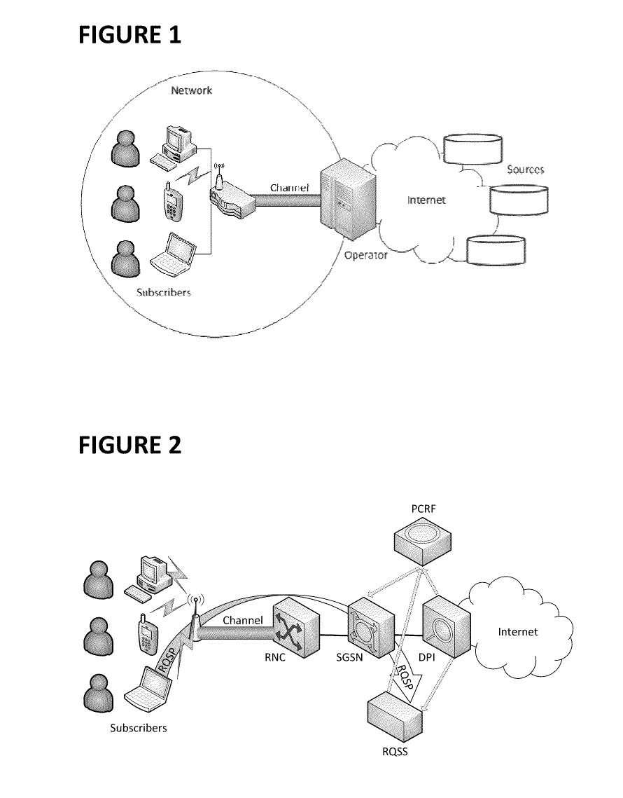

Referring to FIGS. 1 2, and 3 based on various designs and intended industrial applications, the invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task.

The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Referring back to FIGS. 1 and 2, the subject of the invention presents an operation support system (the system) for management of communication channels invention wherein communication is established between service providers and subscribers. The system includes a central request synchronization server (the RQSS), a subscriber software, and a requestor synchronization protocol software (the RSP) for providing interaction between the subscriber software and the RQCC thereby decreases subscriber's activity during channel congestion and allowing for idling of the channel when the subscribers' activity to allow control of the communication channels thereby minimizing the duration of the channels idling and overloading periods and ensure maintenance of the channels loading. The system further includes a communication subsystem that transmits and receives data over the spectrum band. A processing subsystem is in communication with the communication subsystem that processes data received over the communication subsystem and for transmission over the communication subsystem, and a data store storing instructions executable by the processing subsystem, wherein upon execution of the instructions stored in the data store. The processing subsystem and the communication subsystem perform operations also includes sensing an ambient power level for a portion of an electromagnetic spectrum over which the communication device communicates wirelessly; determining, based on the sensed ambient power level, an amount of power required to achieve a desired service within a total permissible power cap during a unit of time; transmitting a bid for an auction of an access allocation to a spectrum access manager that groups received bids into at least two different groups according to their respectively sensed ambient power levels and, for each group of bids, auctions access allocation according to the received bids that belong to the group of bids, the access allocation being an allocation for access to an auctioned portion of the electromagnetic spectrum; determining, in response to the transmitted bid, that a right to transmit data over the access allocation is not granted, and in response to the determination: iteratively incrementing the bid for the auction of the access allocation and transmitting the bid to the spectrum access manager; and determining, in response each transmitted bid, whether a right to transmit data over the access allocation is granted or whether the bid exceeds a maximum bid; and continuing iteratively incrementing the bid and transmitting the bid until a positive determination of one of a right to transmit data over the access allocation is granted or the bid exceeds a maximum bid. The communication subsystem transmits according to a code division multiple access (CDMA) communication protocol, and wherein the access allocation comprises a CDMA channel.

To achieve maximum commercial efficiency of the communication channel within the operating networks, the inventive system provides the following advantages of the prior art systems. In particular, the inventive system decreases of the subscriber's activity (with possible ceasing the network activity) during channel congestion. The invention further provides and allows for “idling” of the channel when the subscribers' activity is low. One of the main advantages of the present invention is to provide an improved and unique system approach to arrange of control of a communication channel, which would minimize the duration of the channel's idling and overloading periods and ensure maintenance of the channel loading on the level close to 100%.

Another advantage of the present invention is ensured by the use of a conceptually new approach (paradigm) to the channel control process, under which the subscribers of the operator are included into the control circuit, while the level of demand for the service and the factors of the subscribers' satisfaction are converted into the input parameters employed in the channel control algorithm. In particular, the system allows to receive information about communication channel accessibility. The information may include current information (to understand the current situation), future information (for planning of activities), and past information (for better quality /validity of planning). The inventive system allows planning their network activity based on the current and forecast communication channel accessibility. The invention will generate signals of their satisfaction in a real time and cooperate with the Operator and other subscribers in order to increase the quality of the services.

The subject of the invention was developed within the project, will be an integrated software solution, intended for the integration into the OSS of communication service providers in order to enhance commercial efficiency of existing communication channels. The system enables its integration into existing OSS with minimum costs risks for networks and current business logics of the Operator. The system enables the subscribers to vividly observe the level of current and perspective (forecasted) loading of a communication channel and to rapidly make decisions with regard to the selection of the optimal time/method of consumption of the services and the price/quality factor of the services.

Alluding to the above, the subscribers are regarded as “generators” of traffic requests and part of a new management paradigm based on: declaration of subscribers' value as part of the channel management system recognition the ability of the subscribers to participate in relationships with Operators and other Subscribers reasonably and responsibly Readiness of Operator to provide Subscriber with information required to participate in such Management Provides interaction of Subscribers' terminal (resident software) with RQSS. The work of the resident software on the Subscriber's terminal is provided in the following modes: Automation mode (“transparent” for the Subscriber). In this mode, the “client” without participation of Subscriber forms data stream helping to identify current tasks and model of the Subscriber's behavior. Mode of <<Wizard>>. Based on RQSS information, <<client>> generates tips—recommendations aimed at optimizing the Subscriber's behavior in the Network. Subscribers can accept the recommendation or reject it.

The system may be operated in a manual mode. In the manual mode, the subscriber can use all ways of obtaining information on current and forecasted utilization of Network to communicate with other subscribers and form own tactics of web surfing. The system also provides no limitations for an individual connection speed. The system includes a channel control algorithm that re-distributes all available channel within all the subscribers, using this channel. The connection speed at any given time is determined dynamically, using the mechanisms of “smart auction>>. Here, the rate quotas “are auctioned” between the subscribers who make different bets.

The channel control algorithm does not operate with “service plans” (each “service plan” is associated with set of fixed connection parameters). Instead, it deals with “priorities” (equivalent to “bets” made by subscribers in the “auction of the resource”). Different algorithms for the channel management in the “surplus resource” mode (nighttime, the channel is free) and the “deficient resource” mode (rush hours, the channel is overloaded). Communication channel control algorithm arranges the Smart Auction of the resource in different manner, depending on current and perspective availability of the resource.

The system also provides for a connection management. Support of several connections for a single Subscriber Formation of several Connections is made through the use of resident software to emulate the presence of multiple network interfaces at the Subscriber's terminal. Different individual connections established for one subscriber may have individual parameters, may be controlled and charged independently.

The system also provides for a microconnection. The microconnection is understood as the individual connection, which is controlled through the use of the following algorithm: the speed of data transmission through the connection in not limited, until the data is transmitted by some small portions, and the aggregate data flow per unit time does not exceed certain predefined value, the connection is automatically blocked, if there is an attempt to use it for transmission of greater volume and/or continuous flow of data.

The system also provides for forecasting resource consumption (communication channel loading), based on the traffic consumption patterns. Traffic Consumption Pattern is understood as the aggregate of the subscriber request parameters, describing current and perspective need of the subscriber in the resource (in the access to the communication channel). Examples of these patterns include loading of file, surfing, watching the YouTube videos, etc.

The system also provides for an interface with the subscriber. The Subscriber's interface formed by the resident software, offers to the Subscriber full-fledged and vivid information on the channel status and the data transmission speeds available for each of the priorities, both current and perspective. Online dataflow on current and perspective traffic consumption models. In the subscriber's interface formed by the resident software, the subscriber is provided with simple and convenient tools of interaction with the operator, which allows the subscriber to inform the operator how (for what purpose) the subscriber uses a particular compound currently, and how he intends to use it in the short term. On the operator's side, the subscriber is provided with automatic “wizards” helping him to make the best decision of priority. “Wizards” are able to optimize the subscribers' solutions based on various criteria: price, speed, stability of speed, etc. In particular, the “wizards” can realize the following modes: <<Communication costs for a period not to exceed a fixed amount>>, <<Notify when the connection speed is reduced below a fixed value>>, <<Automatically maintain the connection speed not lower than the fixed value>>, <<Notify me of the possibility to obtain a given speed at lower cost (on a lower priority)>>. Traditional DPI systems analyze packets and draw their own conclusions “unilaterally” (on the side of the operator). Information from the RQSS server is integrated with DPI information, which provides efficiency of traffic management solutions (efficiency of the channel management).

Interaction with Policy Charging and Rules Function (PCRF) servers. Control actions from the RQSS Server may be transmitted directly to the telecommunication equipment, and “put into practice” indirectly, through the system of traffic distribution policy management (to manage loading of a policy) Telecommunication equipment. In the future, the telecommunication equipment can gain the ability to interact directly with the system server and/or Client on Subscriber's terminal (based on the modified Protocol).

The system provides a conceptually new approach to the channel control process, under which the subscribers of the operator are included into the control circuit, while the level of demand for the service and the factors of the subscribers' satisfaction are converted into the input parameters, employed in the channel control algorithm. Implementation of the new capabilities of the system is ensured through the developing of the algorithms, capable to manage the channel using the methods of the experimental economics. The system is implemented in the form of the software and hardware complex (server side and client side components, specialized interfacing protocol), that allows the subscribers to observe the level of current and perspective (forecasted) load of a communication channel and to rapidly make decisions on selecting the optimal time/method of the services consumption and the price/quality factor of the services, and service provider to flexibly manage the “rules of the game”, within the frameworks of which the subscribers should make their decisions.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An operation support system (the system) for management of communication channels invention wherein communication is established between service providers and subscribers, the system comprising:
a central request synchronization server (the RQSS);
a subscriber software; and
a requestor synchronization protocol software (the RSP) for providing interaction between the subscriber software and the RQCC thereby decreases subscriber's activity during channel congestion and allowing for idling of the channel when the subscribers' activity to allow control of the communication channels thereby minimizing the duration of the channels idling and overloading periods and ensure maintenance of the channels loading.

2. The system as set forth in claim 1, including a communication subsystem that transmits and receives data over the spectrum band.

3. The system as set forth in claim 1, including a processing subsystem in communication with the communication subsystem that processes data received over the communication subsystem and for transmission over the communication subsystem; and a data store storing instructions executable by the processing subsystem; wherein upon execution of the instructions stored in the data store, the processing subsystem and the communication subsystem perform operations comprising: sensing an ambient power level for a portion of an electromagnetic spectrum over which the communication device communicates wirelessly; determining, based on the sensed ambient power level, an amount of power required to achieve a desired service within a total permissible power cap during a unit of time; transmitting a bid for an auction of an access allocation to a spectrum access manager that groups received bids into at least two different groups according to their respectively sensed ambient power levels and, for each group of bids, auctions access allocation according to the received bids that belong to the group of bids, the access allocation being an allocation for access to an auctioned portion of the electromagnetic spectrum; determining, in response to the transmitted bid, that a right to transmit data over the access allocation is not granted, and in response to the determination: iteratively incrementing the bid for the auction of the access allocation and transmitting the bid to the spectrum access manager; and determining, in response each transmitted bid, whether a right to transmit data over the access allocation is granted or whether the bid exceeds a maximum bid; and continuing iteratively incrementing the bid and transmitting the bid until a positive determination of one of a right to transmit data over the access allocation is granted or the bid exceeds a maximum bid.

4. The system as set forth in claim 1, wherein the communication subsystem transmits according to a code division multiple access (CDMA) communication protocol, and wherein the access allocation comprises a CDMA channel.

5. The system as set forth in claim 1, wherein the communication device is a hand-held data and voice communication device.

6. The system as set forth in claim 1, wherein upon execution of the instructions stored in the data store, the processing subsystem further performs the operations of: storing an allocation bid total in the data store; deducting each bid that results in a granting of a transmit right from the allocation bid total; and terminating auction participation if the allocation bid total is less than the bid.

7. The system as set forth in claim 1, further comprising: an access device that transmits and receives data over the spectrum band and transmits and receives data over a network; a spectrum access manager, comprising: a communication subsystem that transmits and receives data over the network; a processing subsystem in communication with the communication subsystem that processes data received over the communication subsystem and for transmission over the communication subsystem; and a data store storing instructions executable by the processing subsystem; wherein upon execution of the instructions stored in the data store, the processing subsystem and the communication subsystem perform operations comprising: receiving bids from the communication device and other communication devices; grouping the bids according to their respectively sensed ambient power levels, and wherein at least two different groups of bids are generated by the grouping of bids; for each respective group of bids, auctioning the access allocation according to the received bids that belong to the group of bids; and transmitting data to the communication device indicating whether a right to transmit data over the access allocation is granted to the communication device.

8. The system as set forth in claim 9, wherein the processing subsystem of the request manager, upon execution of the instructions stored in the data store of the request manager, further performs the operations of: storing an allocation bid total for the communication device in the data store; deducting each bid that results in a granting of a transmit right to the communication device from the allocation bid total; and rejecting a bid from the communication device if the allocation bid total is less than the bid.
